(19) United States
(12) Patent Application Publication
(10) Pub. No.: US 2013/0014617 A1
(43) Pub. Date: Jan. 17, 2013

(54) Socket Tool for Lubricant Fitting

(71) Applicant: James R. Kafka, Mosinee, WI (US)

(72) Inventor: James R. Kafka, Mosinee, WI (US)

(21) Appl. No.: 13/531,522

(22) Filed: Jun. 23, 2012

Related U.S. Application Data
(60) Provisional application No. 61/572,153, filed on Jul. 11, 2011.

(51) Int. Cl. B25B 13/50; B23P 11/00

(52) U.S. Cl. 81/125; 81/180.1; 29/428

(57) ABSTRACT

A socket tool can include a socket having a retention device configured to receive and retain a lubricant fitting to simplify removal or installation of the lubricant fitting. In one example, the retention device can be disposed within the socket between the first and second ends of the socket, and the retention device can be configured to receive and retain a nipple portion of the lubricant fitting at a depth inward from the second end of the socket such that a threaded portion of the lubricant fitting extends beyond the second end of the socket.

### CLAIM FOR PRIORITY

This application claims priority under 35 U.S.C.§119(e) to U.S. Provisional Patent Application No. 61/572,153, filed on Jul. 11, 2011, which is hereby incorporated by reference in its entirety.

### TECHNICAL FIELD

A socket tool can include a socket with a retention device configured to receive and retain a lubricant fitting to simplify removal or installation of the lubricant fitting.

### BACKGROUND

A lubricant fitting, also known as a grease fitting, grease nipple, Zerk fitting, or Alemite fitting, can serve as an orifice for injecting a lubricant, such as oil or grease, into a bearing of a machine without disassembling the machine. The lubricant fitting can thread into an external surface of the machine and can receive a lubricant from a pistol type grease gun or other suitable device. To resist corrosion, lubricant fittings are commonly made of zinc-plated steel, stainless steel, or brass. The lubricant fitting can include a nipple extending outwardly from the fitting, and the nipple can be configured to mate with a nozzle of the grease gun. The lubricant fitting can include a small ball bearing held captive within the nipple, and the ball bearing can be held tightly against an inner perimeter of a hole in the nipple by a retainer spring, thereby sealing the hole in the nipple. During delivery of lubricant from the grease gun to the lubricant fitting, pressure from the lubricant forces the ball bearing inward and away from its position against the inner perimeter of the hole, thereby opening the hole and allowing the lubricant to flow into the lubricant fitting from the nozzle of the grease gun. When lubricant delivery is complete, the grease gun can be detached from the lubricant fitting. The force from the retainer spring then returns the ball bearing to its original position against the inner perimeter of the hole, thereby sealing the hole and preventing the lubricant from flowing out of the hole and preventing debris from entering the hole.

### DESCRIPTION OF DRAWINGS

FIG. 1 is a bottom perspective view of an example socket with a retention device.

FIG. 2 is a perspective view of an example lubricant fitting.

FIG. 3 is a bottom perspective view of an example lubricant fitting disposed within an example socket with a retention device.

FIG. 4 is a bottom perspective view of a conventional socket.

FIG. 5 is a bottom perspective view of an example insert.

### DETAILED DESCRIPTION

A lubricant fitting can be configured to mate with a nozzle of a grease gun or other suitable apparatus that delivers lubricant to the lubricant fitting. In one example, the lubricant fitting 200 can include a nipple 205 having a convex shape that is configured to mate with a concave nozzle of the grease gun. As shown in FIG. 2, the lubricant fitting 200 can have a threaded portion 215 near a first end that allows the lubricant fitting to be threaded into a threaded hole in a machine, such as near a bearing that requires periodic supplemental lubrication. The nipple 205 can be located at a second end 240 opposite the first end 235. Between the first and second ends, the lubricant fitting 200 can have a hexagonal portion 210 that allows the lubricant fitting 200 to be gripped by a tool, such as a socket or a wrench, during installation or removal of the lubricant fitting from the threaded hole in the machine.

At the second end 240, the lubricant fitting 200 can have a top surface 225 having a hole 230. The lubricant fitting 200 can include a ball bearing 220 held captive within the nipple 205, and the ball bearing 220 can be held tightly against an inner perimeter of the hole 230 by a retainer spring disposed within the lubricant fitting, thereby sealing the hole 230 in the nipple 205. During delivery of the lubricant from the grease gun to the lubricant fitting 200, pressure from the lubricant forces the ball bearing 220 inward from its position against the hole 230, thereby opening the hole and allowing the lubricant to flow into the lubricant fitting from the nozzle of the grease gun. When lubricant delivery is complete, the grease gun can be detached from the lubricant fitting. The force from the retainer spring then returns the ball bearing 220 to its original position against the inner perimeter of the hole 230, thereby sealing the hole and preventing the lubricant from flowing out of the lubricant fitting. The lubricant fitting can be made of zinc-plated steel, stainless steel, brass, or any other suitable material that is corrosion resistant.

Due to the repeated metal on metal contact associated with attaching and detaching the nozzle of the grease gun to and from, respectively, the lubricant fitting 200, the lubricant fitting and nozzle can experience wear that necessitates replacement of each. Wear is often accelerated by the environment in which the machine operates. For example, machinery equipped with lubricant fittings often operates in unclean locations where debris collects around the lubricant fittings. Exposure to debris, such as sand, gravel, or metal shavings, can cause the lubricant fitting to wear over time. In one example, debris can cause the captive ball bearing to wear and pit over time, and once the ball bearing becomes worn, it may not adequately seal against the perimeter of the hole, and leaking of lubricant can occur. If the lubricant fitting begins leaking, it must be replaced.

The lubricant fitting is a relatively inexpensive part that can be replaced without disassembling the machine, so replacement can be accomplished quickly and inexpensively. On the other hand, failure to replace a failed lubricant fitting can be very costly. For instance, if the ball bearing fails to seal the hole properly, lubricant can leak from the bearing and cause a lack of lubrication, which can result in bearing failure. In a second example, if the lubricant fitting fails to seal the hole properly, debris can enter the bearing through the hole 230 in the nipple 205 and cause physical damage to the bearing. In both scenarios, costly repairs would be needed. Conducting routine inspections and replacing worn lubricant fittings is a cost-effective way to reduce operating expenses and downtime.

Traditionally, a standard wrench, crescent wrench, or socket wrench would be used to replace a worn lubricant fitting with a new lubricant fitting. A socket wrench can include a driver having a drive member that attaches to a conventional socket 400, as shown in FIG. 4. The drive member is commonly connected to a ratchet assembly disposed within a head of the driver. During use, the drive member transfers torque from the driver to the socket. The drive member can be part of a manual hand tool or an automated system, such as a robotic assembly line including, for example, hydraulic or pneumatic drivers. The socket can be cylindrical in shape and can have a through hole extending from a first end 405 to a second end 410 of the socket. The first end 405 of the socket can have a first opening 415 that is configured to receive the drive member, which can be a rectangular prism having a square cross section normal to the direction of insertion into the through hole. The second end 410 of the socket can have a second opening 420 configured to engage a hexagonal portion 210 of the lubricant fitting 200, similar to the way a socket engages a hexagonal bolt head.

Holding and aligning the lubricant fitting 200 during installation has long been a problem. During installation, a conventional socket 400 conceals the lubricant fitting 200 and the threaded hole into which the lubricant fitting is being installed, so the user must guess whether the lubricant fitting is properly aligned with the threaded hole when they begin ratcheting the driver. To further frustrate installation, the hexagonal portion 210 of the lubricant fitting has six side portions that have relatively small surface areas, which, in some instances, do not provide adequate stability against the inner surfaces (e.g. 425) of the conventional socket 400. As a result, the lubricant fitting 200 can experience play within the conventional socket and may not remain aligned with a central axis 430 of the conventional socket 400 during installation. This can make it very difficult to get the lubricant fitting 200 to start threading into the threaded hole properly.

Depending on the orientation of installation, other difficulties can arise when using a conventional socket 400 to install the lubricant fitting 200. For example, when the user is installing the lubricant fitting 200 in a location that requires the second end 410 of the conventional socket 400 to be higher than the first end 405 of the socket, the user must be concerned with the lubricant fitting sliding too far inside the socket, since this causes the conventional socket 400 to completely conceal the threaded portion 215 of the lubricant fitting 200, and thereby prevents the threads 215 from engaging with the mating threads of the threaded hole in the machine. When the user is installing the lubricant fitting in a location that requires the first end 405 of the conventional socket 400 to be higher than the second end 410 of the socket, the user must be concerned about the lubricant fitting 200 falling out of the socket onto a potentially unclean surface, such as a floor. If the lubricant fitting falls on the floor, it must then be cleaned before reattempting installation in order to prevent debris from being introduced into the threaded hole in the machine. Often the user must try several times to install the lubricant fitting 200 before experiencing success.

Using a conventional socket 400 to install a lubricant fitting 200 can increase the likelihood of cross-threading the lubricant fitting and damaging the machine. Cross-threading occurs when the threads 215 of the lubricant fitting 200 are not correctly aligned with the threads of the threaded hole. Cross-threading can be costly if the threads of the threaded hole are damaged to an extent that the threaded connection no longer seals properly. In that case, the hole in the machine must be drilled larger and re-tapped, often resulting in downtime and lost productivity, since great care must be taken to ensure that no metal shavings are introduced into the bearing housing during the drilling and tapping process.

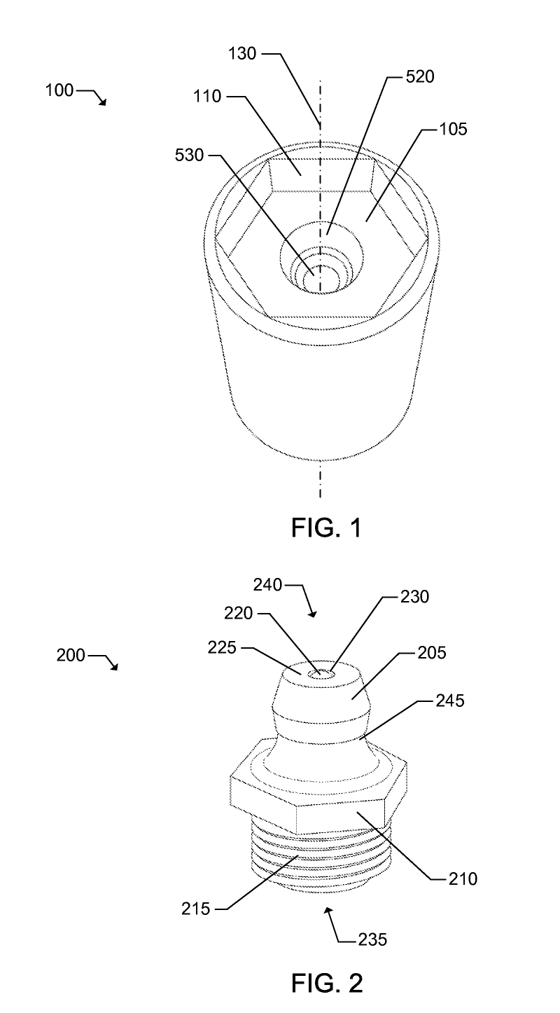

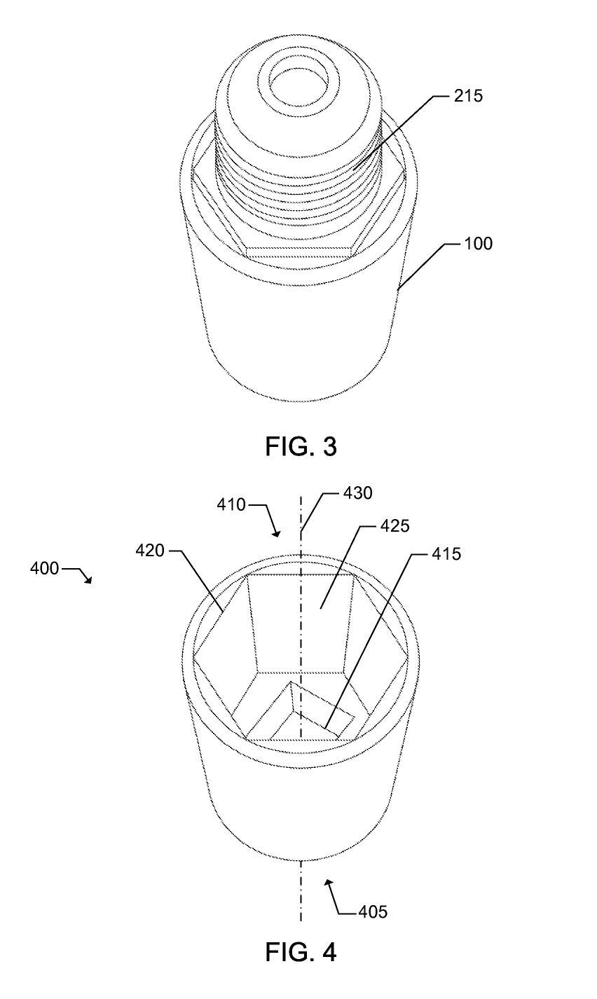

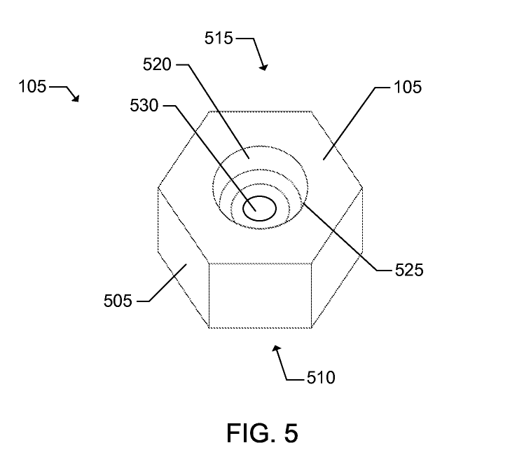

To improve the ease and efficiency of installing and removing the lubricant fitting 200, a new socket has been developed. An example socket 100 is shown in FIG. 1. The socket 100 is configured to hold a lubricant fitting 200 in a position that facilitates installation and removal of the lubricant fitting, as shown in FIG. 3. The socket 100 can include a retention device, such as an insert 105 (as shown in FIGS. 1 and 5), a magnet, a mechanical device (e.g. a spring-loaded ball), a combination thereof, or any other suitable retention device that can retain the lubricant fitting 200 in a fixed position within the socket and thereby prevent it from moving relative to the socket 100 during use. More specifically, the retention device can be disposed within the socket 100 between the first and second ends (405, 410) of the socket 400. The retention device can be configured to receive and retain a nipple portion 205 of the lubricant fitting 200 at a depth inward from the second end 410 of the socket such that a threaded portion 215 of the lubricant fitting 200 extends beyond the second end of the socket 100. In one example, the entire threaded portion 215 of the lubricant fitting 200 can extend beyond the second end 410 of the socket 100, as shown in FIG. 3. In another example, less than the entire threaded portion 215 of the lubricant fitting 200 can extend beyond the second end 410 of the socket 100. The depth inward at which the lubricant fitting 200 is retained within the socket tool 100 can be controlled by the placement of the retention device within the socket. In one example, the depth inward can be fixed. In another example, the depth inward can be adjustable to allow for compatibility with different types of lubricant fittings. For example, depending on the thickness of the hexagonal portion 210 of the lubricant fitting 200, which can vary depending on the brand and model of lubricant fitting, it can be desirable to adjust the location of the retention device within the socket tool to accommodate the lubricant fitting 200 at an appropriate depth to ensure reliable performance of the socket tool.

The features described herein are particularly helpful when installing or removing a lubricant fitting 200 that is located in hard-to-reach locations on a machine. For example, as the lubricant fitting 200 is unthreaded from a machine, the lubricant fitting is captured and retained by the socket 100, as opposed to falling onto the floor, which is common with a conventional socket 400. Also, during installation, the socket 100 will capture and retain the lubricant fitting 200 as it is threaded into the threaded hole on the machine, thereby preventing the lubricant fitting 200 from falling out of the socket or from sliding too far into the socket, as is common with a conventional socket 400. In this way, the socket 100 assists in maintaining cleanliness of the lubricant fitting 200 during installation and, by preventing debris from entering the bearing, can increase the bearing's useful life and reduce operating costs. Once the lubricant fitting 200 has been adequately tightened into the threaded hole, the user can disengage the socket tool 100 from the lubricant fitting by simply pulling the socket tool back and away from the installed lubricant fitting with sufficient force. In another example, if the socket tool 100 is equipped with a mechanical retention device, the user can actuate the mechanical retention device to disengage the socket tool 100 from the lubricant fitting 200.

In one example, the retention device can be an insert 105 as shown in FIGS. 1 and 5. The insert 105 can have a first end 510 and a second end 515 opposite the first end. The insert 105 can have a hexagonal outer portion 505 configured to fit within a socket 100 having a hexagonal inner portion 110. The hexagonal outer portion 505 of the insert 105 can be configured to mate with the hexagonal inner portion 110 of the socket 100. In one example, there can be an interference fit, such as a press fit or friction fit, between the hexagonal outer portion 505 of the insert 105 and the hexagonal inner portion 110 of the socket 100. The interference fit can be any suitable type of fit. For example, the interference fit can be minimal to permit the insert 105 to be removed from the socket 100 when it is unneeded and thereby allow the socket 100 to be used for other tasks. In another example, the interference fit can be substantial and can provide a permanent or semi-permanent fit between the insert 105 and socket 100, thereby providing a socket that is dedicated to installation and removal of lubricant fittings. Alternately, instead of an interference fit, an adhesive, or any other suitable fastening method, can be used to retain the insert 105 within the socket 100.

The socket 100, which is configured to receive the hexagonal portion 210 of the lubricant fitting 200, can have a standard 6-point hexagonal inner portion as shown in FIG. 1. Alternately, the inner portion 110 of the socket can have a non-hexagonal shape, such as a 12-point shape or any other shape capable of engaging the hexagonal portion 210 of the lubricant fitting 200 (e.g. 4-point, 6-point, 8-point, 12-point, spline, or clutch drive). To provide a suitable fit, the outer portion 505 of the insert 105 can have any suitable shape that is configured to mate with the particular shape of the inner portion 110 of the socket 100.

The insert 105 can have a recess 520 extending inward from the second end 515 of the insert. The recess 520 can be configured to receive and retain the nipple portion 205 of the lubricant fitting 200. For example, there can be an interference fit between the nipple portion 205 and the recess 520 of the insert 105 upon insertion. The interference fit can be any fit suitable to prevent the nipple portion 205 from dropping out of the recess 520 due to gravity. The insert 105 can be made of any suitable material. In one example, the insert can be made of a polymer, such as, for example, synthetic rubber, Bakelite, neoprene, nylon, PVC, polystyrene, polyethylene, polypropylene, polyacrylonitrile, PVB, silicone, cellulose, natural rubber. Alternately, any other suitable material can be used.

The insert can have a through hole 530 extending from the first end 510 of the insert to the recess 520, as shown in FIG. 5. The through hole 530 can allow air to exit the recess 520 as the nipple portion 205 is inserted into the recess 520, and, likewise, can allow air to enter the recess as the nipple portion 205 is removed from the recess 520. In both scenarios, the through hole 530 can ease inserting and removing the nipple portion of the lubricant fitting into and from, respectively, the recess 520 in the insert 105. The though hole 530 can also provide access to forcibly eject the lubricant fitting 200 from the insert 105 if required. For example, if a worn lubricant fitting 200 becomes stuck in the recess 520 during removal, a screwdriver, or other long, slender tool can be inserted into the through hole 530 to apply force against the nipple portion 205 of the lubricant fitting 200 to dislodge if from the insert 105.

In one example, to allow the insert 105 to receive and retain the lubricant fitting 200, the recess 520 can have a recess entrance 525 that is the narrowest portion of the recess 520 and can be narrower than the widest portion of the nipple portion 105. Consequently, as the user inserts the nipple portion 205 into the recess 520, the lubricant fitting 200 can snap into place as the widest diameter of the nipple portion 205 passes through the recess entrance 525, since the recess entrance 525 must stretch in diameter to accommodate the widest diameter of the nipple portion 205 and then returns to its original diameter after it passes. In one example, and depending on the elasticity of the material selected for the insert, the recess entrance 525 can have a diameter that is 0.001-0.020, 0.001-0.050, 0.001-0.100, 0.001-0.200, or 0.001-0.250 inches less than the widest diameter of the nipple portion 205, where the widest diameter is measured normal to the direction of insertion. Adjusting the material of the insert 105 and the amount of interference of the fit will dictate the magnitude of the snap that occurs as the lubricant fitting 200 is inserted into the recess entrance 520. Hearing, feeling, or seeing the lubricant fitting 200 snap into place can provide acoustic, tactile, or visual feedback to the user to instill confidence that the lubricant fitting 200 has been received and is being retained by the socket tool 100. Once the lubricant fitting 200 is fully inserted into the recess 520, the recess entrance 525 of the insert 105 can coincide with a necked down portion 245 of the nipple portion 205. As a result, the threaded portion 215 of the lubricant fitting 215 can extend beyond the second end of the socket 100, thereby facilitating ease of installation, as shown in FIG. 3.

Instead of an interference fit between the recess 520 and the nipple portion 205, the recess 520 can provide a clearance fit. In this way the recess can simply lend stability to the nipple portion 205 and thereby maintain alignment of the lubricant fitting 200 with the central axis 130 of the socket 100. In this example, the recess would not serve entirely as the retention device. Instead, another device can also be used to assist in retaining the nipple portion 205 within the recess 520. Any suitable device can be used. In one example, a mechanical device can be used, such as a spring-loaded ball or actuator pin. The mechanical device can extend inward toward a central axis 130 of the socket 100 from an inner surface of the recess 520 and can align with a necked down portion 245 of the nipple portion 205 of the lubricant fitting 200 when fully inserted. In another example, a magnet can be used to retain the nipple portion 205 within the recess 520. The magnet can be located proximate the recess 520 and can exert a magnetic force on the nipple portion 205 of the lubricant fitting, which is often made of a ferrous material. In another example, the mechanical device can serve as the retention device without the insert. For instance a magnet can be positioned within the socket at an appropriate depth to contact and retain the lubricant fitting at a proper depth within the socket to allow the threaded portion of the lubricant fitting to extend beyond the second end of the socket. Alternately, the magnet can be replaced with any other suitable mechanical device, such as a spring-loaded ball, actuator pin, or a series of flexible fingers extending inward from the inner surfaces (e.g. 425) of the socket and pressing against the necked down portion of the nipple portion 205 to retain the lubricant fitting within the socket. The flexible fingers can be made of any suitable material, such as polymer or metal. In one example, there can be three or more flexible fingers extending inward from inner surfaces (e.g. 425) of the socket.

In one example, a socket tool can include a socket having a first end and a second end, wherein the first end includes a first opening configured to receive a drive member, and wherein the second end includes a second opening configured to engage a hexagonal portion of a lubricant fitting. The socket tool can include a retention device disposed within the socket between the first and second ends of the socket, wherein the retention device is configured to receive and retain a nipple portion of the lubricant fitting at a depth inward from the second end of the socket such that a threaded portion of the lubricant fitting extends beyond the second end of the socket. The retention device can include an insert having a recess configured to receive the nipple portion of the lubricant fitting. The insert can include a polymer such as, for example, synthetic rubber, Bakelite, neoprene, nylon, PVC, polystyrene, polyethylene, polypropylene, polyacrylonitrile, PVB, silicone, cellulose, or natural rubber. The socket can include a through hole extending from the first opening to the second opening, and the insert can include a through hole extending from the first end of the insert to the recess in the insert.

In one example, the retention device can include a spring-loaded device to assist in retaining the lubricant fitting at a depth inward from the second end of the socket such that a threaded portion of the lubricant fitting extends beyond the second end of the socket. The spring-loaded device can include a spring-loaded ball extending inward toward a central axis of the socket from an inner surface of the recess in the insert and can be configured to press against a necked down portion of the nipple portion of the lubricant fitting. Alternately, or in addition to the spring-loaded device, the retention device can include a magnet located proximate the recess in the insert and configured to attract the nipple portion of the lubricant fitting.

In another example, an insert for a socket tool can include a first end and a second end opposite the first end, an outer portion configured to fit within a socket, and a recess extending into the insert from the second end of the insert, wherein the recess is configured to receive and retain a nipple portion of a lubricant fitting. The recess can be configured to provide an interference fit with the nipple of the lubricant fitting. The recess can include a recess entrance having a diameter less than a maximum diameter of the nipple portion, and the recess entrance can be configured to stretch in diameter to accommodate the nipple portion of the lubricant fitting during insertion or removal. The insert can include a through hole extending from the first end of the insert to the recess. The insert can include a polymer such as, for example, synthetic rubber, Bakelite, neoprene, nylon, PVC, polystyrene, polyethylene, polypropylene, polyacrylonitrile, PVB, silicone, cellulose, or natural rubber.

In yet another example, a method for manufacturing a socket tool can include providing a socket having a first end and a second end, wherein the first end includes a first opening configured to receive a drive member, and wherein the second end includes a second opening configured to engage a hexagonal portion of a lubricant fitting. The method can include installing a retention device within the socket between the first and second ends of the socket, wherein the retention device is configured to receive and retain a nipple portion of the lubricant fitting at a depth inward from the second end of the socket such that a threaded portion of the lubricant fitting extends beyond the second end of the socket. Installing a retention device can include installing an insert having a recess that is configured to receive the nipple portion of the lubricant fitting. Installing an insert can include installing a polymer insert made of, for example, synthetic rubber, Bakelite, neoprene, nylon, PVC, polystyrene, polyethylene, polypropylene, polyacrylonitrile, PVB, silicone, cellulose, or natural rubber. Installing a retention device can include installing a mechanical device comprising a spring-loaded ball extending inward toward a central axis of the socket from an inner surface of the recess of the insert. Installing a retention device can include installing a magnet proximate an inner surface of the recess of the insert.

Details of one or more embodiments are set forth in the accompanying drawings and description. Other features, objects, and advantages will be apparent from the description, drawings, and claims. Although a number of embodiments of the invention have been described, it will be understood that various modifications may be made without departing from the spirit and scope of the invention. For example, the socket and insert can be a single, cast piece including a retention device. It should also be understood that the appended drawings are not necessarily to scale, presenting a somewhat simplified representation of various features and basic principles of the invention.

What is claimed is:

1. A socket tool, comprising:
a socket comprising a first end and a second end, wherein the first end comprises a first opening configured to receive a drive member, and wherein the second end comprises a second opening configured to engage a hexagonal portion of a lubricant fitting; and
a retention device disposed within the socket between the first and second ends of the socket, wherein the retention device is configured to receive and retain a nipple portion of the lubricant fitting at a depth inward from the second end of the socket such that a threaded portion of the lubricant fitting extends beyond the second end of the socket.

2. The socket tool of claim 1, wherein the retention device comprises an insert comprising a recess configured to receive the nipple portion of the lubricant fitting.

3. The socket tool of claim 2, wherein the insert comprises a polymer comprising synthetic rubber, Bakelite, neoprene, nylon, PVC, polystyrene, polyethylene, polypropylene, polyacrylonitrile, PVB, silicone, cellulose, or natural rubber.

4. The socket tool of claim 1, wherein the retention device further comprises a spring-loaded device.

5. The socket tool of claim 4, wherein the spring-loaded device comprises a spring-loaded ball extending inward toward a central axis of the socket from an inner surface of the recess in the insert and configured to press against a necked down portion of the nipple portion of the lubricant fitting.

6. The socket tool of claim 2, wherein the retention device further comprises a magnet located proximate the recess in the insert and configured to attract the nipple portion of the lubricant fitting.

7. The socket tool of claim 2, wherein the socket comprises a through hole extending from the first opening to the second opening, and wherein the insert comprises a through hole extending from the first end of the insert to the recess in the insert.

8. An insert for a socket tool, the insert comprising:
a first end and a second end opposite the first end;
an outer portion configured to fit within a socket; and
a recess extending into the insert from the second end of the insert, wherein the recess is configured to receive and retain a nipple portion of a lubricant fitting.

9. The insert of claim 8, wherein the recess is configured to provide an interference fit with the nipple of the lubricant fitting.

10. The insert of claim 9, wherein the recess comprises a recess entrance having a diameter less than a maximum diameter of the nipple portion, and wherein the recess entrance is configured to stretch in diameter to accommodate the nipple portion of the lubricant fitting during insertion or removal.

11. The insert of claim 8, further comprising a through hole extending from the first end of the insert to the recess.

12. The insert of claim 8, wherein the insert comprises a polymer comprising synthetic rubber, Bakelite, neoprene, nylon, PVC, polystyrene, polyethylene, polypropylene, polyacrylonitrile, PVB, silicone, cellulose, or natural rubber.

13. A method for manufacturing a socket tool, the method comprising:
providing a socket comprising a first end and a second end, wherein the first end comprises a first opening configured to receive a drive member, and wherein the second end comprises a second opening configured to engage a hexagonal portion of a lubricant fitting; and
installing a retention device within the socket between the first and second ends of the socket, wherein the retention device is configured to receive and retain a nipple portion of the lubricant fitting at a depth inward from the second end of the socket such that a threaded portion of the lubricant fitting extends beyond the second end of the socket.

14. The method of claim 13, wherein installing a retention device comprises installing an insert comprising a recess configured to receive the nipple portion of the lubricant fitting.

15. The method of claim 14, wherein installing the insert comprises installing a polymer insert comprising synthetic rubber, Bakelite, neoprene, nylon, PVC, polystyrene, polyethylene, polypropylene, polyacrylonitrile, PVB, silicone, cellulose, or natural rubber.

16. The method of claim 14, wherein installing the retention device comprises installing a mechanical device comprising a spring-loaded ball extending inward toward a central axis of the socket from an inner surface of the recess of the insert.

17. The method of claim 14, wherein installing a retention device comprises installing a magnet proximate an inner surface of the recess of the insert.
